(19) United States
(12) Patent Application Publication
(10) Pub. No.: US 2020/0029720 A1
(43) Pub. Date: Jan. 30, 2020

(54) Ergonomic Handheld Citrus Press

(71) Applicant: Mahmoud Razzaghi, Laguna Niguel, CA (US)

(72) Inventor: Mahmoud Razzaghi, Laguna Niguel, CA (US)

(21) Appl. No.: 16/406,831

(22) Filed: May 8, 2019

Related U.S. Application Data
(60) Provisional application No. 62/712,040, filed on Jul. 30, 2018.

(51) Int. Cl. A47J 19/02; A23N 1/00

(52) U.S. Cl. CPC A47J 19/02; A23N 1/003

(57) ABSTRACT

An ergonomic handheld citrus press allowing the use of closed fists and large force of the arms for comfortable and efficient operation, as opposed to the use of open fist and small force in conventional presses.

The ergonomic press is comprised of a first and a second elongated member hinged together at one end. The first member has a concave part with straining holes and the second member has a smaller convex part near the hinge. A first handle extends from the concave part and a second handle extends from the convex part at the opposite side of the hinge.

The first and second member may be rotated toward each other such that the concave part receives the convex part. In closed condition of the press, the handles are parallel and spaced apart by about 5 cm.

The user places a cut half of a citrus such as lemon in the concave part, holds the first handle in one fist and the second handle in another fist, and closes the press against the lemon. The lemon is squeezed between the concave and convex parts and its juice drips out of the straining holes. The distance between the handles provides space for the fists for full closure of the press and comfortable and efficient squeezing of the lemon.

This application has priority date of provisional patent application 62/712,040 filed 30 Jul. 2018.

### FIELD OF THE INVENTION

This invention relates to hand presses for pressing citrus fruits and garlic and cracking nuts.

### BACKGROUND OF THE INVENTION

Existing handheld citrus presses as shown in FIG. 1, have a first member comprised of a first cup approximately in hemispherical shape with a longitude as first handle extending from the rim of the first cup, and a similar second member with a second cup and a second handle. The first cup is larger than the second cup and has a few straining holes at its bottom. The two members are hinged together at their rim side opposite to the handle and can rotate toward each other such that the first cup receives the second cup in its cavity. For squeezing, the user places half of a citrus such as lemon in the cavity of the first cup and rotates the second member toward the first member. Then, the user holds the two handles and pushes them against each other. The smaller cup pushes against the lemon and squeezes its juice. The juice drips out of the straining holes. At the end of the process, the solid part of the lemon remains between the two cups and the handles come together.

In the above design, the pressing parts and the handles are on one side of the hinge. In a different design that works like pliers, the handles and the pressing parts are at opposite sides of the hinge. This design has a smaller leverage and is harder to operate relative to the above design.

These citrus presses have an ergonomic draw back which makes them inefficient. The only way to operate the press is to hold both handles in one hand and push them together between the fingers and the palm of the hand. This design has three drawbacks in comfort and operational performance:
1. The required force for this operation is generally more than the comfort level of the user.
2. Holding the handles in open position at the beginning of the operation requires a relatively large hand.
3. At the beginning of the pressing operation, the hand is anatomically in a weak open position and has limited ability to exert the required force.
   As a result, the citrus fruit cannot be squeezed comfortably and efficiently and part of it is wasted.

### OBJECTS OF THE INVENTION

Therefore, the object of the present invention is to provide a press for citrus fruits, garlic or nuts that is both ergonomic and operationally effective. This object is achieved by a design that allows the use of closed fists of both hands to hold the handles, and the naturally much larger force of wrists and arms for the pressing operation.

### DESCRIPTION OF THE DRAWINGS

FIG. 1 shows the prior art.

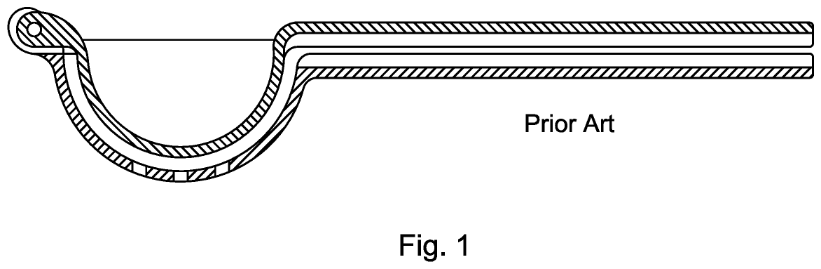

FIG. 2 shows a preferred embodiment of the invention.

### DESCRIPTION OF THE INVENTION

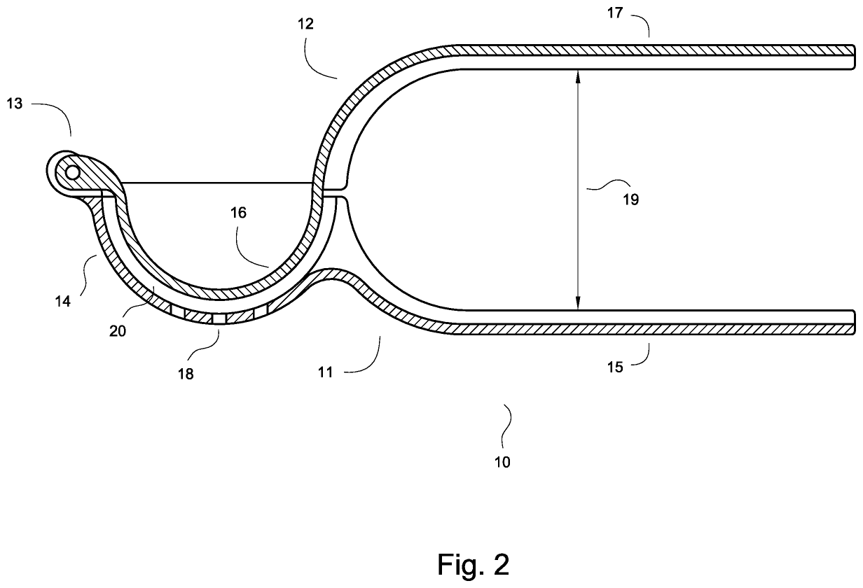

According to FIG. 2 there is a citrus press 10 comprised of two elongated members 11 and 12. Member 11 has concave part 14 and handle 15. Member 12 has convex part 16 and handle 17. Concave part 14 has straining holes 18. Members 11 and 12 are attached rotatably with hinge 13 near the rims of concave part 14 and convex part 16 opposite to the location of handles 15 and 17. Members 11 and 12 can rotate toward each other such that concave part 14 receives convex part 16 during closure of the press. In closed condition, convex part 16 is fully inside concave part 14, and handles 15 and 17 are parallel and spaced apart by distance 19.

The user places a cut half of a citrus fruit such as lemon in the concave part 16. Then, the user holds handle 15 in one fist and handle 17 in another fist, and pushes the two handles toward each other and closes press 10 against the lemon with the force of the wrists and arms. The lemon is squeezed between concave part 14 and convex part 16 and its juice drips out of straining holes 18. The pressed lemon will be in space 20 between concave part 14 and convex part 16. When press 10 reaches its closed position or end of pressing, distance 19 provides the space and clearance needed for the two fists.

The comfortable holding of handles 15 and 17 with the fists and the ability to use the relatively large force of the fist and arms allows efficient and full squeezing of the lemon.

Distance 19 is about 5 cm which includes 2 cm for the thickness of fingers in each hand and 1 cm clearance between the fists. In closed state of press 10, the citrus fruit is in squeezed form, and handles 15 and 17 are nearly parallel.

A preferred way of operating citrus press 10 is to hold handle 15 in a direction perpendicular to the front side of the body with one fist such that the back of the fist faces downward and concave part 14 faces upward. The other hand holds handle 17 and rotates it downward toward handle 15. In closed state of citrus press 10, the back of the fist on handle 17 faces upward.

As part of the invention, same configuration of spaced apart handles is applicable to pliers style citrus press.

The concept of the invention is also applicable to garlic press and nut cracker.

I claim:

1. An ergonomic handheld citrus press allowing the use of closed fists and large force of the arms for comfortable and efficient operation, as opposed to the use of open fist and small force in conventional presses, the ergonomic press is comprised of:
a first and a second elongated members hinged together at one end,
the first member has a cup shaped concave part with a few straining holes,
the second member has a cup shaped convex part,
the concave and convex parts are close to the hinge,
a first handle extends from the concave part at the opposite side of the hinge,
a second handle extends from the convex part at the opposite side of the hinge,
The first and second elongated members may be rotated toward each other such that the concave part receives the convex part,
in the final stage of rotation, or closed condition of the press, the handles are parallel and spaced apart to provide clearance between the two fists of a user holding each handle separately,
the user places a cut half of a citrus such as lemon in the concave part, holds the first handle in one fist and the second handle in another fist, and closes the press against the lemon, the lemon is squeezed between the concave and convex parts and its juice drips out of the straining holes,
the distance between the handles provides space for the fists for full closure of the press and comfortable and efficient squeezing of the lemon.

2. the ergonomic handheld citrus press of claim 1 wherein the distance between handles in closed state of the press is 4 to 5 cm.

3. An ergonomic handheld press for pressing food such as citrus or garlic, or cracking nuts, the press allowing the use of closed fists and large force of the arms for comfortable and efficient operation, as opposed to the use of open fist and small force in conventional presses, the ergonomic press is comprised of:
a first and a second elongated member hinged together,
the first member has a first pressing part,
the second member has a second pressing part,
the concave and convex parts are near the hinge,
a first handle extends from the first pressing part,
a second handle extends from the second pressing part,
The first and second handles may be rotated toward each other such that the first and second pressing parts also rotate toward each other,
in the final stage of rotation, or closed condition of the press, the first and second pressing parts are at their nearest distance relative to each other, and the handles are parallel and spaced apart where to provide clearance between the two fists of a user holding each handle separately,
the user places a the food item to be pressed between the first and second pressing parts, holds the first handle in one fist and the second handle in another fist, and closes the press against the food item,
the distance between the handles provides space for the fists for full closure of the press and comfortable and efficient pressing of the food item.

4. The ergonomic handheld press of claim 3 wherein the distance between handles in closed state of the press is 4 to 5 cm.

5. The ergonomic handheld press of claim 3 wherein the hinge is on one side of the pressing parts and the handles.

6. The ergonomic handheld press of claim 3 wherein the hinge is between the pressing parts and the handles.
